(19) United States
(12) Patent Application Publication
(10) Pub. No.: US 2002/0167818 A1
(43) Pub. Date: Nov. 14, 2002

(54) Vehicle headlamp assembly with heat conductive cover member

(76) Inventor: Kenji Yoneima, Anjo-city (JP)

Correspondence Address: LAW OFFICES OF DAVID G. POSZ, 2000 L STREET, N.W., SUITE 200, WASHINGTON, DC, 20036, US

(21) Appl. No.: 10/140,081

(22) Filed: May 8, 2002

(30) Foreign Application Priority Data
May 14, 2001 (JP) 2001-143484

(51) Int. Cl. F21V 29/00; B60Q 1/00

(52) U.S. Cl. 362/547; 362/294; 362/373

(57) ABSTRACT

A headlamp assembly includes a cover member detachably mounted to a headlamp housing. A lighting control circuit is disposed in the housing opposite to the cover member, and directly connected to a discharge bulb. The cover member is an aluminum die-casting, and therefore has high heat conductance. Further fins are integrally formed on the cover member, and the cover member is entirely painted black. According to this construction, the heat generated by the lighting control circuit is transferred to the inner surface of the cover member by radiation, and further conducted to the outer surface efficiently. Then the heat is radiated from the outer surface so as to be blown off, and thereby rise in the internal temperature of the lighting control circuit is suppressed.

### CROSS REFERENCE TO RELATED APPLICATION

The present application is based on and incorporates herein by reference Japanese Patent Application No. 2001-143484 filed on May 14, 2001.

### BACKGROUND OF THE INVENTION

1. Field of the Invention

The present invention relates to a vehicle headlamp assembly that employs a discharge lamp, which is especially suitable for an automobile.

2. Related Art

Nowadays a discharge lamp is often employed as a vehicle headlamp. The discharge lamp is an arc discharge lamp which generates light by means of an internal electrical discharge between a pair of electrodes in a discharge bulb (arc tube) filled with xenon. The discharge lamp can generate white light close to sunlight. Further the discharge lamp can generate light in double intensity using 70% reduced energy in comparison with a conventional halogen lamp. Accordingly the visibility is improved if the discharge lamp is employed as a headlamp of a vehicle.

In this case, the vehicle should include a lighting control circuit dedicated to the discharge lamp. The lighting control circuit includes a converter, an inverter and an igniter. The converter converts a d.c. voltage supplied by the battery into a higher voltage. The inverter converts the d.c. voltage into an a.c. voltage. The igniter generates a high voltage of few score kilovolts required for starting the discharge lamp.

When the discharge lamp is turned on, the lighting control circuit applies a high voltage of several kilovolts or few score kilovolts to the discharge lamp so that electrical discharge immediately begins. Thus the discharge lamp is instantaneously started. Thereafter the lighting control circuit keeps the discharge lamp on by supplying power of approximately 35W to the discharge lamp.

The lighting control circuit is usually outside the housing of a headlamp assembly in the vehicle. In this case, a wire for transferring the high voltage should be connected between the lighting control circuit and the discharge lamp, and further a connector is required to connect the wire to the discharge lamp. Therefore the headlamp assembly cannot be miniaturized and occupies a relatively large space in the vehicle. Further a relatively large amount of manpower is required for mounting and wiring the headlamp assembly in or to the vehicle. Further a shield is required for blocking electrical noises generated in the wire, and thereby costs are increased.

Then it is proposed that the lighting control circuit is disposed in the headlamp housing so that the lighting circuit or its part may be directly connected to the discharge bulb. For example, it is proposed that the lighting control circuit with a built-in connector is fixed to the backside of the reflector so that the discharge bulb is directly connected to the built-in connector. According to this construction, the headlamp assembly can be miniaturized and the wire for transferring the high voltage is not required. As a result, noises and/or the power loss due to transmission of the high voltage through the wire are prevented.

However, while the discharge bulb is lighted, the discharge bulb has a high temperature and therefore the air in the headlamp housing also has a high temperature. The headlamp housing usually has an air vent for reducing pressure difference between its inside and its outside. However the air vent is extremely small so that water and/or foreign matter are prevented from getting into the housing. Therefore the air hardly flows in the housing.

Further the lighting control circuit also has a high temperature due to the heat of the electronic parts included therein. Therefore the heat load on the circuit elements included in the lighting control circuit may be excessive according to the above construction in which the lighting control circuit is disposed in the headlamp housing. In order to overcome this problem, circuit elements and a substrate which have high heat-resistance may be employed. However, in this case, the costs are increased and the headlamp assembly is increased in size.

### SUMMARY OF THE INVENTION

The present invention has an object to provide a vehicle headlamp assembly that has a heat conductive cover member through which the heat generated by a lighting circuit within the headlamp housing can be blown off.

A vehicle headlamp assembly according to the present invention includes a discharge bulb, a reflector, a lighting circuit, a housing, and a cover member. The discharge bulb, the reflector and the lighting circuit are disposed in the housing. The housing includes a lens integrated therewith. The reflector is provided for reflecting light radiated from the discharge bulb. The lighting circuit is fixed to the backside of the reflector, and directly connected to the discharge bulb for lighting the discharge bulb. The housing includes an opening opposite to one end of the lighting circuit. The cover member is detachably mounted to the housing so as to close up the opening. Then the cover member is opposite to and distanced from the end of the lighting circuit. At least a portion of the cover member is made of a heat conductive material, for example metal.

Preferably, fins are formed on the inner surface and/or the outer surface of at least a portion of the cover member. Further the inner surface and/or the outer surface of at least a portion of the cover member are painted black.

### BRIEF DESCRIPTION OF THE DRAWINGS

The above and other objects, features and advantages of the present invention will become more apparent from the following detailed description made with reference to the accompanying drawings. In the drawings:

FIG. 1 is a vertical section of a headlamp assembly according to a first embodiment of the present invention;

FIG. 2 is an exploded perspective view of the main parts of the headlamp assembly shown in FIG. 1; and

FIG. 3 is a fragmentary sectional view of a headlamp assembly according to a second embodiment of the present invention.

### DETAILED DESCRIPTION OF THE PREFERRED EMBODIMENT

(First Embodiment)

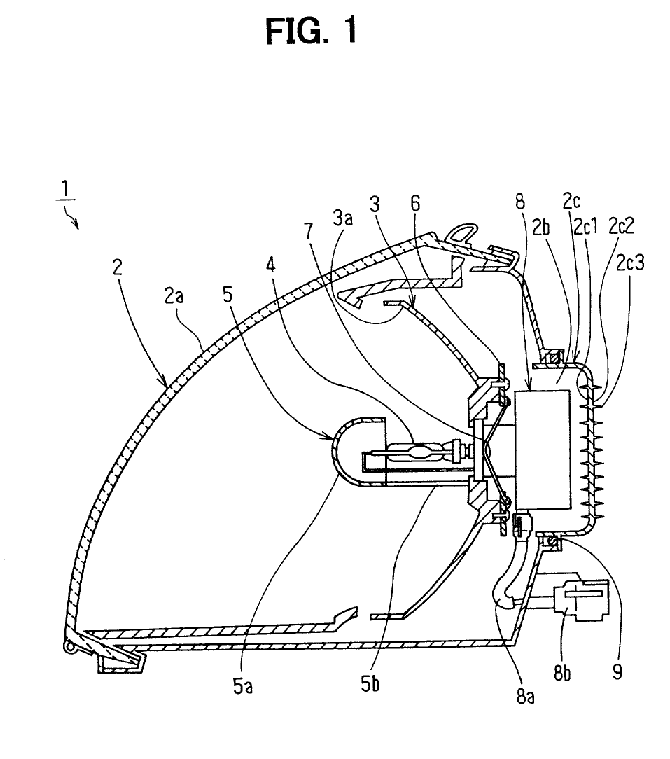

Referring to FIG. 1, a headlamp assembly 1 according to a first embodiment of the present invention includes a housing 2, a reflector unit 3, a discharge bulb 4, a lampshade unit 5, a lighting control circuit 8, and a holder 6. The left side of FIG. 1 corresponds to the front side of a vehicle. The housing 2 is a resinous molding, and includes a translucent lens 2a integrated therewith as shown in FIG. 1. The reflector unit 3, the discharge bulb 4, and the lighting control circuit 8 are housed in the housing 2.

The reflector unit 3 includes a concave reflector 3a on its front side (i.e., discharge bulb side). The discharge bulb 4 is partially covered with the lampshade unit 5 so that light radiated by the discharge bulb 4 does not travel straightforward. The holder 6 is mounted to the backside of the reflector unit 3. The lighting control circuit 8 is fixed to and retained by the holder 6. Thus the lighting control circuit 8 is mounted to the backside of the reflector unit 3 across the holder 6.

The housing 2 includes an opening 2b corresponding to the lighting control circuit 8. The opening 2b is generally circular, and constructed so that the discharge bulb 4 and the holder 6 can pass through the opening 2b. A cover member 2c is detachably mounted to the housing 2 so as to close up the opening 2b. An O-ring 9 is disposed between the periphery of the opening 2b and the cover member 2c so that the housing 2 is kept airtight.

The cover member 2c is made of a material which has high heat conductance. For example, the cover member 2c is an aluminum die-casting. Fins 2c3 are integrally formed on the inner surface 2c1 and outer surface 2c2 of the cover member 2c. The cover member 2c is entirely painted black so as to be a blackbody.

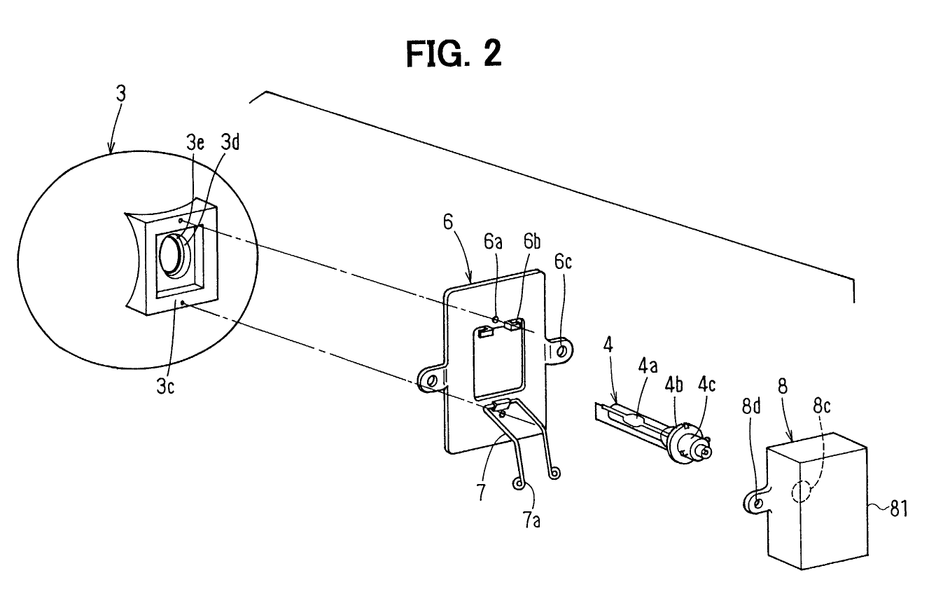

Referring to FIG. 2, the discharge bulb 4 includes a lamp 4a, and further includes a flange 4b and a male connector 4c on one side of the lamp 4a. The flange 4b is engaged with and retained by the reflector unit 3. The connector 4c is electrically connected to the lighting control circuit 8.

Returning to FIG. 1, the lampshade unit 5 is made of metal, and includes a generally semispherical lampshade 5a and a supporting portion 5b. One end of the supporting portion 5b supports the lampshade 5a, while the other end is fixed to the reflector unit 3. The lampshade 5a is arranged so as to shield the front portion of the discharge bulb 4. Thereby the straightforward component of the light emitted by the discharge bulb 4 is blocked. As a result, light radiated forward includes only the light reflected by the reflector 3a. That is, the light which has an intensity distribution provided by the reflector 3a is radiated forward. The lampshade 5a also blocks electromagnetic noises which are radiated from the discharge bulb 4 straightforward.

Referring to FIG. 2 again, the reflector unit 3 includes the reflector 3a on its front side as described above, and further includes a retainer 3d at its center. The reflector unit 3 is entirely made of metal. However the reflector unit 3 may be made of more than two kinds of materials including both of metal and nonmetal (e.g., resin). For example, the reflector unit 3 is originally made of resin, and thereafter aluminum is deposited on the surface of the resinous structure.

In order that the headlamp assembly 1 may serve a predetermined function, the discharge bulb 4 (particularly the lamp 4a) should be arranged in a predetermined position with respect to the reflector 3a. Therefore the reflector unit 3 includes a stopper 3e for positioning the discharge bulb 4. The flange 4b of the discharge bulb 4 is engaged with the retainer 3d of the reflector unit 3, and the lamp-side end face of the flange 4b is brought into intimate contact with the stopper 3e of the reflector unit 3. Thereby the discharge bulb 4 is held exactly in the predetermined position with respect to the reflector unit 3.

The reflector 3a of the reflector unit 3 reflects forward the light radiated from the discharge bulb 4. The reflector 3a is constructed so that the light reflected by the reflector 3a has the predetermined intensity distribution as described above. The reflector unit 3 further includes a bearing surface 3c on which the holder 6 is disposed. The holder 6 is fixed to the bearing surface 3c of the reflector unit 3, and then the lighting control circuit 8 is mounted to the holder 6. That is, the lighting control circuit 8 is fixed to the reflector unit 3 across the holder 6 as described above.

The lighting control circuit 8 includes electrical circuits in a rectangular parallelepiped casing 81, and thereby the discharge bulb 4 is lighted. The electrical circuits include a converter, an inverter and an igniter. The converter converts a d.c. voltage supplied by the battery (not shown) into a higher voltage. The inverter converts the d.c. voltage into an a.c. voltage. The igniter generates a high voltage of few score kilovolts required for starting the discharge bulb 4.

The lighting control circuit 8 includes a built-in female connector 8c. The discharge bulb 4 is directly connected to the female connector 8c without using a wire lead. A lead wire 8a with a connector 8b is connected to the lighting control circuit 8, and the power from the battery is supplied to the lighting control circuit 8 through the lead wire 8a. The casing 81 includes mounting holes 8d, and thereby the lighting control circuit 8 is fixed to the holder 6.

The holder 6 is made of resin or metal. The holder 6 includes holes 6a, and thereby screwed to the bearing surface 3c of the reflector unit 3. The holder 6 further includes threaded holes 6c to which the lighting control circuit 8 is fixed. A spring 7 for biasing the discharge bulb 4 against the reflector unit 3 is pivotably supported by the holder 6. Further the holder 6 includes latches 6b for holding the ends 7a of the spring 7.

The present headlamp assembly 1 is assembled as follows. The lampshade unit 5 is mounted to the reflector unit 3 beforehand. Further the reflector unit 3 with the lampshade unit 5 is disposed in the housing 2 beforehand. However the cover member 2c is not attached to the housing 2 as yet.

The holder 6 is put into the housing 2 through the opening 2b, and screwed to the bearing surface 3c of the reflector unit 3. The spring 7 is pivotably mounted to the holder 6 beforehand. Next, the discharge bulb 4 is put into the housing 2 through the opening 2b, and mounted to the reflector unit 3 so that the flange 4b of the discharge bulb 4 rests in the retainer 3d of the reflector unit 3 and the end face of the flange 4b is in intimate contact with the stopper 3e. Thereafter the ends 7a of the spring 7 are hooked onto the latches 6b so that the discharge bulb 4 is biased against the reflector unit 3.

Then the male connector 4c of the discharge bulb 4 is inserted into the female connector 8c of the lighting control circuit 8, and thereafter the mounting holes 8d of the lighting control circuit 8 are fixed to the threaded holes 6c by screws. Thus the lighting control circuit 8 is mounted to the reflector unit 3.

Next, the power from the battery is supplied to the lighting control circuit 8 so that the discharge bulb 4 is lighted, and then the optical axis is adjusted by setting up the reflector unit 3 through the opening 2b. Finally, the O-ring 9 is attached on the periphery of the cover member 2c, and thereafter the cover member 2c with the O-ring 9 is attached to the housing 2 so as to close up the opening 2b. Then the assembly is finished.

The discharge bulb 4 can be replaced through the opening 2b and further the lighting control circuit 8 can be overhauled through the opening 2b, even when the headlamp assembly 1 is mounted in the vehicle

According to the present embodiment, the following advantages are provided. The lighting control circuit 8 is opposite to the cover member 2c, and therefore the heat generated by the lighting control circuit 8 is transferred to the inner surface 2c1 of the cover member 2c by radiation. The heat transferred to the inner surface 2c1 is efficiently conducted to the outer surface 2c2, because the cover member 2c is made of aluminum as described above. Then the heat is radiated from the outer surface 2c2 of the cover member 2c so as to be blown off.

Thus the heat generated by the lighting control circuit 8 is blown off through the cover member 2c. Thereby rise in internal temperature of the lighting control circuit 8 is suppressed, and therefore the heat load on the circuit elements of the lighting control circuit 8 is reduced. In contrast, if the cover member 2c made of a material (e.g., resin) which has low heat conductance is employed, the heat transferred to the cover member 2c can be blown off only slightly.

Further according to the present embodiment, the heat-receiving area of the cover member 2c, which receives the heat radiated from the lighting control device 8, is relatively large, because the fins 2c3 are formed on the inner surface 2c1 of the cover member 2c. The heat-radiating area of the cover member 2c, from which the heat received from the lighting control device 8 is radiated, is also relatively large, because the fins 2c3 are also formed on the outer surface 2c2 of the cover member 2c.

Moreover, the cover member 2c can absorb the heat radiated from the lighting control circuit 8 at a high rate and radiate the absorbed heat at a high rate, since the cover member 2c is entirely painted black. Consequently the cover member 2c can absorb a relatively large amount of the heat radiated from the lighting control circuit 8, and blow off a relatively large amount of the absorbed heat.

The entire or the igniter of the lighting control circuit 8 corresponds to a lighting circuit of the present invention.

(Second Embodiment)

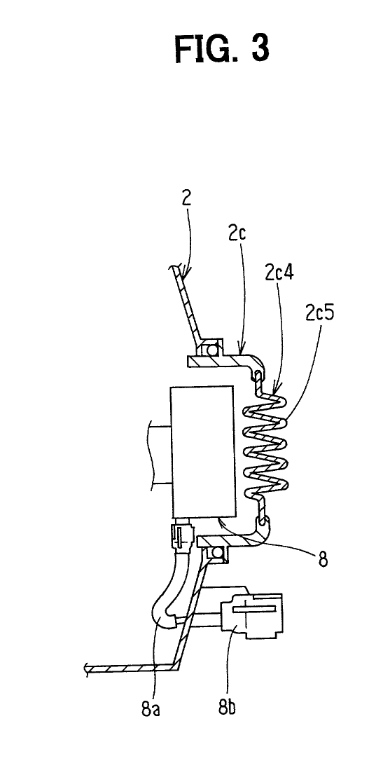

A headlamp assembly according to a second embodiment of the present invention includes a cover member 2c made of resin and metal. Referring to FIG. 3, the cover member 2c includes a radiator 2c4 opposite to a lighting control circuit 8. The radiator 2c4 is made of metal such as steel or aluminum, and the other portions of the cover member 2c are made of resin. Fins are formed on the radiator 2c4 by press molding. The other portions of the cover member 2c are attached to the radiator 2c4 by insert molding.

The other portions of the headlamp assembly are similar to the first embodiment. According to the present embodiment, the advantages similar to the first embodiment are also provided.

(Modifications)

In the first embodiment, the fins 2c3 are formed on both of the inner surface 2c1 and the outer surface 2c2 of the cover member 2c. However, the fins 2c3 may be formed on one of the inner surface 2c1 and the outer surface 2c2.

In the first embodiment, the cover member 2c is entirely painted black. However one of the inner surface 2c1 and the outer surface 2c2 may be painted black. Further a method other than painting may be employed for making the cover member 2c black. For example, chemical treating such as plating may be employed.

In the first embodiment, instead of aluminum, another material which has high heat conductance may be employed for making the cover member 2c. For example, resin or ceramics which has high heat conductance may be employed.

Further in the first embodiment, at least one of the inner surface and the outer surface of the housing 2 may be made black except the lens 2a. In this case, the heat radiated from the lighting control circuit 8 is blown off through not only the cover member 2c but also the housing 2.

In the above embodiments, the entire of the lighting control circuit 8 is provided as a single part. However, the lighting control circuit 8 may consist of a plurality of separate portions. For example, the lighting control circuit 8 consists of two separate portions, that is, a first portion and a second portion. The first portion includes only the igniter. The second portion includes the converter and the inverter. In this case, the first portion (i.e., igniter) may be fixed to the reflector unit 3, and the second portion may be fixed in another appropriate position within the housing 2. The second portion is connected with the first portion by a wire.

The present invention is not limited to the above embodiments and modifications, but may be variously embodied within the scope of the invention.

What is claimed is:

1. A vehicle headlamp assembly comprising:
a discharge bulb;
a reflector for reflecting light radiated from said discharge bulb;
a lighting circuit for lighting said discharge bulb, said lighting circuit being fixed to a backside of said reflector and directly connected to said discharge bulb;
a housing in which said discharge bulb, said reflector and said lighting circuit are disposed, said housing including an opening opposite to an end of said lighting circuit and further including a lens; and
a cover member detachably mounted to said housing so as to close up said opening, wherein:
said cover member is arranged so as to be opposite to and distanced from said end of said lighting circuit; and
at least a portion of said cover member is made of a heat conductive material.

2. A vehicle headlamp assembly as in claim 1, wherein said heat conductive material is metal.

3. A vehicle headlamp assembly as in claim 1, wherein at least one of an inner surface and an outer surface of at least a portion of said cover member is made black.

4. A vehicle headlamp assembly as in claim 1, wherein a fin is formed on at least one of an inner surface and an outer surface of at least a portion of said cover member.

5. A vehicle headlamp assembly as in claim 1, wherein at least one of an inner surface and an outer surface of said housing is made black except said lens.

6. A vehicle headlamp assembly as in claim 3, wherein at least one of the inner surface and the outer surface of at least a portion of said cover member is made black by painting.
